(19) United States
(12) Patent Application Publication
(10) Pub. No.: US 2016/0198730 A1
(43) Pub. Date: Jul. 14, 2016

(54) PRODUCE RIPENING CHAMBER

(71) Applicant: Alan GARRATT, West Thurrock Essex (GB)

(72) Inventors: Alan GARRATT, West Thurrock Essex (GB); Neil TURBITT, Rayleigh Essex (GB)

(21) Appl. No.: 14/912,375

(22) PCT Filed: Jun. 5, 2014
(86) PCT No.: PCT/IB2014/061985

§ 371 Date: Feb. 16, 2016

(30) Foreign Application Priority Data
Aug. 15, 2013 (EP) 13180570.7

(51) Int. Cl. A23B 7/152

(52) U.S. Cl. CPC A23B 7/152; A23V 2002/00

(57) ABSTRACT

A produce ripening chamber is described which comprises an air conditioning system for circulating air through the chamber and regulating the air temperature and a doping system for regulating the concentration of a ripening agent in the recirculated air. The chamber 10 has a floor 12, a ceiling 14 and side walls 16 extending between the floor 12 and the ceiling 14. At least one kerb 20 is arranged on the floor for spacing a pallet 24 resting on the floor 12 from a side wall 16 and a duct 18 arranged is at the ceiling end of the latter side wall 16 to seal against the side facing the latter side wall of an upper produce box supported by the pallet. In this way, an air flow channel 30, 32 is defined between the boxes 20 stacked on the pallet 24 and the side wall 16. An air blower 42 and a heat exchanger 40 of the air conditioning system are housed within the duct 18 to force air at a controlled temperature to circulate through the air flow channel 30, 32, through the produce boxes 20 supported by the pallet 24 and through a clearance volume 36 lying between the stack of boxes and the ceiling of the chamber. No part of any duct extends laterally beyond the associated kerb so as not to overlie produce boxes supported on a pallet, thereby allowing the full height of the chamber to be used for stacking produce boxes.

### FIELD OF THE INVENTION

The present invention relates to a produce ripening chamber that may form part of a stationary installation or of a transport container for distribution of agricultural produce.

### BACKGROUND OF THE INVENTION

In order to ripen produce, such as bananas, it is known to place pallets carrying stacks of boxes containing the produce in a ripening chamber in which they are exposed to a re-circulating flow of air at a controlled temperature and containing metered amounts of a ripening agent, usually ethylene. The boxes have holes in their sides, as well as in their bases and lids, to that the air circulating in the ripening chamber passes through the boxes and over the produce.

As well as constructing ripening chambers as rooms in fixed buildings, it has also been proposed to use a transport container for distribution of agricultural produce as a ripening chamber. Such a transport container defines a sealed controlled environment for ripening the produce while in transit and/or while stationed in a depot, and comprises a plurality of fans for circulating air over pallets of the produce, an air conditioning system for maintaining the air circulated by the fans at a desired temperature, and a doping system for maintaining the concentration of a ripening agent in the circulated air at a desired level.

Known ripening chambers, be they mobile or stationary, that circulate air in a plane normal to the length of the chambers, have ceiling mounted ducts and fans for recirculating the air over the pallets. In certain situations, in particular, though not exclusively, if the ripening room is intended to be built into a standard transport container, the chamber has a restricted head height and some of that height is taken up by the ducts carrying the recirculating air.

It has also been proposed to circulate the air by blowing it axially down the length of the chamber but while this allows the full head height of the chamber to be used for accommodating stacked boxes containing the produce, this creates a gradient along the chamber that results in uneven and uncontrolled ripening, which affects the shelf life of the produce.

Pallets carrying produce boxes come in standard sizes and the boxes are either stacked eight high in standard pallets containing forty eight boxes to a pallet, or nine high in so called “high cube” pallets, that support fifty four boxes and need to be transported in larger high cube containers. If a high cube container is used as the basis for a ripening room, the positioning of the ducts and fans on the ceiling restricts the available height for produce boxes and only eight high standard pallets can be accommodated.

### OBJECT OF THE INVENTION

The present invention seeks therefore to provide a ripening chamber configuration that is less demanding of head height.

### SUMMARY OF THE INVENTION

According to the present invention, there is provided a ripening chamber comprising an air conditioning system for circulating air through the chamber and regulating the air temperature and a doping system for regulating the concentration of a ripening agent in the recirculated air, wherein the chamber has a floor, a ceiling and side walls extending between the floor and the ceiling, at least one kerb on the floor for spacing a pallet resting on the floor from a side wall and a duct arranged at the ceiling end of the latter side wall and operative to seal against the side facing the latter side wall of an upper produce box supported by the pallet so as to define an air flow channel between the boxes stacked on the pallet and the side wall, wherein at least an air blower and a heat exchanger of the air conditioning system are housed within the duct to force air at a controlled temperature to circulate in a plane normal to the length of the chamber through the air flow channel, the produce boxes supported by the pallet and a clearance volume lying between the stack of boxes and the ceiling of the chamber, wherein the width of the duct is equal to or narrower than the width of the associated kerb, whereby an unobstructed space constituting the clearance volume is defined between boxes supported on a pallet and the ceiling of the chamber.

In the invention, because no part of any duct overlies the boxes resting on the pallets, the entire height of the chamber is available for the loaded pallets. Such an unencumbered clearance volume is required not only to allow air circulating through the boxes to return to the ducts while the chamber is in use but also to allow the pallets to be raised, for example using a fork lift truck, while being loaded into, and unloaded from, the ripening chamber.

If the pallets have boxes stacked eight high, then the duct will seal against the uppermost boxes, but if the boxes are stacked nine height, the duct will seal against the next to uppermost boxes but will have sufficient height to ensure that the air flow into and out of the duct is not obstructed by the ninth box.

In an embodiment of the invention, the chamber is symmetrical about a central plane and has kerbs adjacent both of the side walls and ducts near the upper ends of opposite side walls.

Conveniently, the chamber is an elongate chamber or rectangular cross section divided along its length into two or more ripening zone, the air conditioning systems in the individual ripening zones being controllable independently of one another.

A partition, which is preferably sealed and thermally insulating, may in some embodiments be provided in the chamber to separate adjacent pairs of ripening zones from one another.

### BRIEF DESCRIPTION OF THE DRAWINGS

The invention will now be described further, by way of example, with reference to the accompanying drawings, in which:

FIG. 1 is a section through a ripening chamber of the invention taken in the plane I-I in FIG. 3,

FIG. 2 is a section similar to that of FIG. 1 showing the ripening chamber filled with produce boxes stacked on pallets,

FIG. 3 is a section in plane III-III in FIG. 1,

FIG. 4 is a section in the plane IV-IV in FIG. 2,

FIG. 5 is a side view of one of the air conditioning ducts in FIG. 1,

FIG. 6 is a section in the plane VI-VI in FIG. 5,

FIG. 7 is a section through the duct of FIG. 5 in the plane designated VII-VII in FIG. 6,

FIG. 8 is a rear view of a transport container designed also to act as a ripening chamber,

FIG. 9 is a front view of the container shown in FIG. 8 with front doors closed, and

FIG. 10 shows the compartments accessible by opening the front doors of the container.

### DETAILED DESCRIPTION OF THE EMBODIMENT

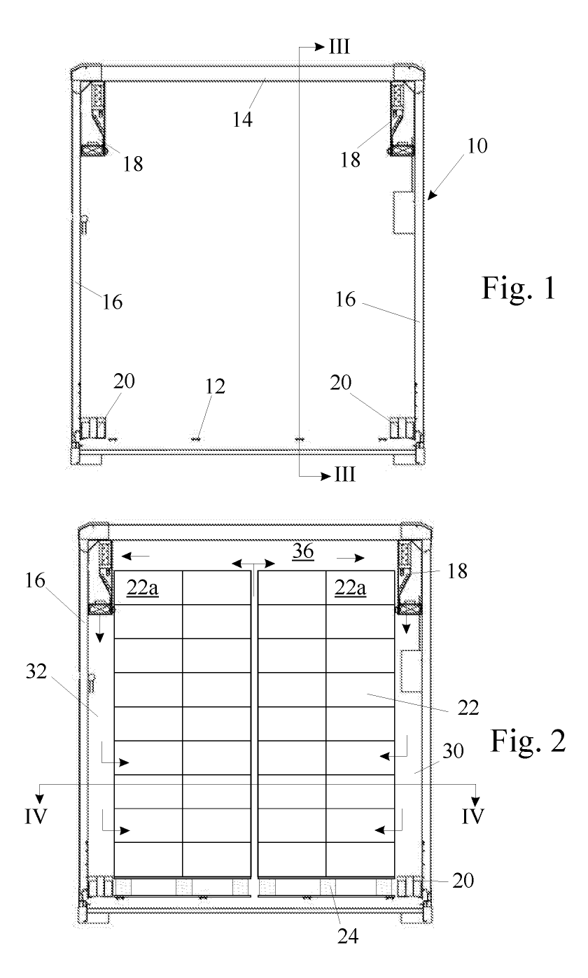

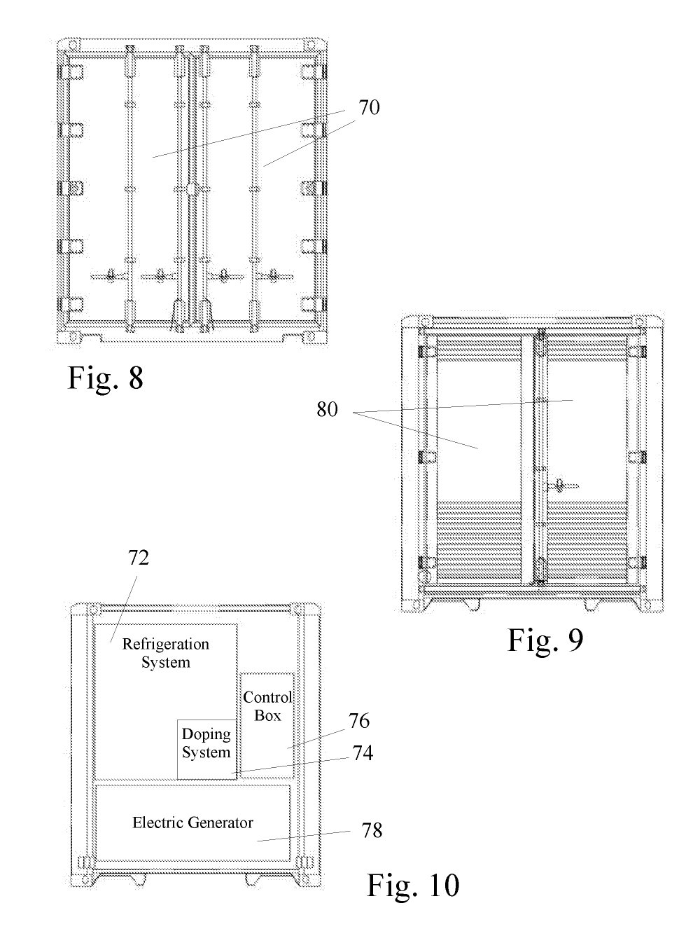

FIG. 1 shows a vertical section through an empty ripening chamber 10 formed within the rear part of a transport container. The exterior of the container may be of conventional design with hinged doors 70 at the rear end, shown in FIG. 8, to allow access to the ripening chamber. The front end of the container has a refrigeration system 72, a doping system 74, a control box 76 and, if required, an electric generator 78 with its own fuel supply, shown in FIG. 10, housed behind front doors 80 shown in FIG. 9.

The ripening chamber 10 has a floor 12, a ceiling 14 and two opposing side walls 16 extending over the length of the ripening chamber 10. Two ducts 18 extend along the corners between the side walls 16 and the ceiling 14 and two kerbs 20 are provided in the corners between the floor 12 and the side walls 16 to help in positioning pallets. Aside from acting as spacers sealing against the sides of the pallets, the kerbs 20 include grills and controlled dampers to admit fresh air into the air circulation circuit and allow air to escape to the ambient atmosphere.

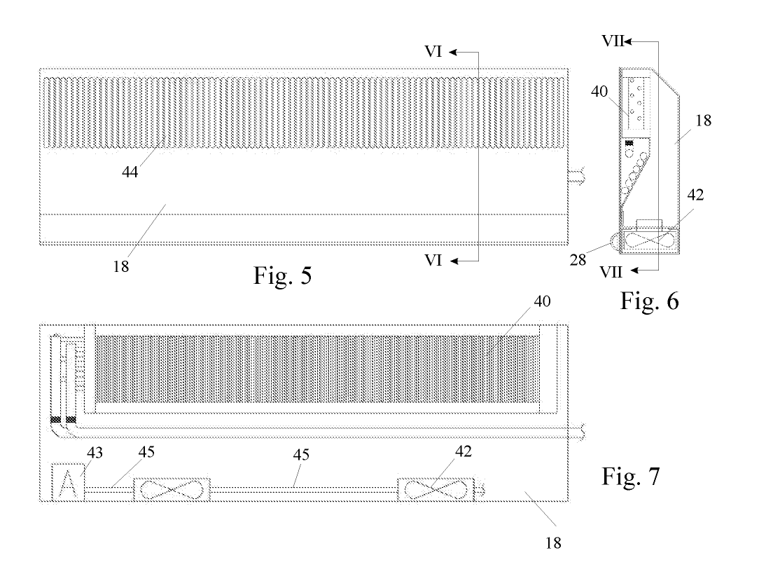

The same ripening chamber 10 is shown in FIG. 2 when filled with produce boxes 22, stacked nine high on pallets 24. When the pallets 24 abut the kerbs 20, the sides of the next to uppermost boxes 22a abut and seal against the ducts 18, thereby forming two air circulation channels 30 and 32 between the stacks of boxes 22 and the side walls 16 of the ripening chamber 10. The seal between the boxes and the sides of ducts 18 may be by means of laterally projecting sealing pads 28 on the ducts 18 (see FIGS. 5 and 6).

As better shown in FIGS. 5, 6 and 7, the ducts 18 house heat exchange units 40 and fans 42. The fans 42, as shown in FIG. 7, are mechanically connected to one another and to an actuator 43 by shafts 45 that allow the fans to be rotated about the axis of the shafts 45, to reverse the direction of air circulation. While it would alternatively be possible to reverse the direction of rotation of the fan blades electrically, mechanical rotation is preferred as it is more energy efficient.

The heat exchange units 40 are located behind louver-like vents 44 in the side walls of the ducts to communicate with a clearance volume 36 between the boxes 22 stacked on the pallets 20 and the ceiling 14 of the ripening chamber 10. The fans 42 on the other hand communicate through openings in the bottom walls of the ducts 18 with the circulation channels 30 and 32. Thus, when the fans 42 are operating, air is drawn through the vents 44, and is blown into the circulation channels 30 and 32 by the fans 42 after having first passed through the heat exchanger 40. The air then flows through holes in the sides of the boxes 20 and over the produce to be ripened before returning to the clearance volume 36, thereby completing the circuit, which is represented by arrows in FIG. 2.

The reversing of the fans 42 serves to allow the direction of the air flow to be reversed. It is desirable to reverse the direction of air flow periodically in order to achieve more even ripening across the width of the pallet.

The heat exchangers 40 form part of a closed cooling circuit filled with a coolant comprising water and anti-freeze. The coolant is itself cooled in a heat exchanger by the refrigeration circuit that is housed in the compartment 72 and that uses propane or other non-toxic liquid as a refrigerant. The refrigeration system may be conventional, being formed of a compressor, an expansion valve and an evaporator. The temperature of the coolant flowing through the heat exchanger 40 is regulated to maintain the circulating air at a desired temperature.

The doping system may comprise an ethylene generator for introducing metered quantities of ethylene into the ripening chamber. When the concentration of the ripening agent is to be reduced, air is discharge to atmosphere from within the ripening chamber and replaced by fresh air. The ripening chamber communicates with the ambient air through the controlled dampers built into in the kerbs 20. To avoid the need for special extraction fans, it is possible to open the dampers on the opposite sides of the ripening chamber and to reverse the direction of circulation in only one half of the chamber. In this way, the fan on one side acts to draw fresh air through the damper in its kerb while the fan on the opposite side expels air through its associated damper.

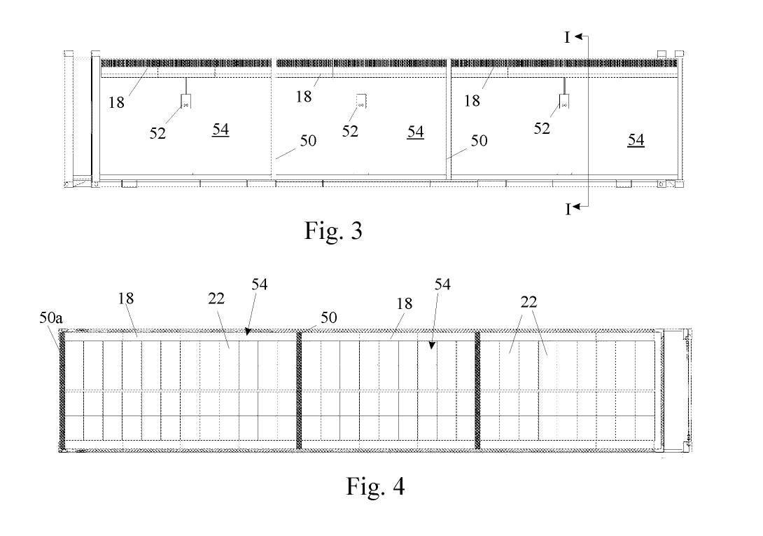

Referring now to FIG. 3, it will be seen that along its length the ripening chamber is divided by partitions 50 into three compartments 54 each of which has its own control box 52. The partitions, which extend across the full width of the ripening chamber, are preferably sealed and thermally insulating so that adjacent compartments 54 may have different temperatures and concentrations of ripening agent. Hence, each partition may comprise a frame and a door hinged at its upper end about a horizontal hinge to stow away when open against the ceiling of the ripening chamber. The partitions may alternatively be formed of roller blinds guided in suitable channels to seal against the walls of the chamber.

The control boxes 52 are shown as being wall mounted for ease of operation, but if there is a risk of their interfering with the air flow, then they may alternatively be mounted within the kerbs 20.

The temperature, humidity, and ripening agent concentration in each of the compartments 54 can be set independently so that either different types of produce can be ripened at the same time or the same produce can be ripened at three different rates. In order to achieve this, the coolant circuits and the doping circuits of the three compartments can be regulated independently of one another.

An advantage of the design of the ripening chamber shown in the drawings is that the full height of the chamber is used to accommodate boxes stacked on pallets and no part of the headroom is taken up by ducts or fans, the latter being accommodated entirely within the space available between the sides of the boxes and the adjacent side walls of the container. Though maximising of the headroom within the ripening chamber is of particular importance when it is constructed within a transport container, the same architecture may be used in stationary installations where the head height may also be at a premium.

When implemented as a container, it is important to be able to access the interior of the ripening chamber even when the container is docked at a loading bay. This is enabled in the case of the container shown in FIG. 8 by the doors 70 being able to be hinged back to lie flush against the outside of the side walls of the container before the container is reversed into the loading bay. As can be seen in FIG. 4, a sealed and thermally insulating partition 50a of suitably modified construction is provided to maintain the rearmost compartment 54 sealed even when the container doors are open.

Though the illustrated embodiment is symmetrical about its centre line, it should be noted that this is not essential as there need only be one kerb and one duct when the chamber is only wide enough to accommodate one pallet.

While there need only be one refrigeration circuit, the coolant circulation through the heat exchangers of the separate compartments may be controlled independently from one another.

It has so far been assumed that the air conditioning system is required only to cool the circulating air but in certain circumstances it may be required to heat it. While it may be possible to reverse the refrigeration circuit to act as a heater, it is preferred for the heat exchangers 40 to act as heaters by incorporating electrical heating elements into them as this would allow one compartment to be heated while others are being cooled if they are all connected to a common refrigeration circuit.

1. A ripening chamber comprising an air conditioning system for circulating air through the chamber and regulating the air temperature and a doping system for regulating the concentration of a ripening agent in the recirculated air, wherein the chamber has a floor, a ceiling and side walls extending between the floor and the ceiling, at least one kerb on the floor for spacing a pallet resting on the floor from a side wall and a duct arranged at the ceiling end of the latter side wall and operative to seal against the side facing the latter side wall of an upper produce box supported by the pallet so as to define an air flow channel between the boxes stacked on the pallet and the side wall, wherein at least an air blower and a heat exchanger of the air conditioning system are housed within the duct to force air at a controlled temperature to circulate in a plane normal to the length of the chamber through the air flow channel, the produce boxes supported by the pallet and a clearance volume lying between the stack of boxes and the ceiling of the chamber, wherein the width of the duct is equal to or narrower than the width of the associated kerb, whereby an unobstructed space constituting the clearance volume is defined between boxes supported on a pallet and the ceiling of the chamber.

2. A ripening chamber as claimed in claim 1, wherein the chamber is symmetrical about a central plane and has kerbs adjacent both of the side walls and ducts near the upper ends of opposite side walls.

3. A ripening chamber as claimed in claim 1, wherein the chamber is an elongate chamber of rectangular cross section divided along its length into two or more ripening compartments, the air conditioning systems and doping systems in the individual ripening compartments being controllable independently of one another.

4. A ripening chamber as claimed in claim 3, comprising curtains in the chamber to separate adjacent pairs of ripening compartments from one another.

5. A ripening chamber as claimed in claim 1, wherein the air blower is reversible.

6. A ripening chamber as claimed in claim 5, wherein the air blower is a fan that is rotatably mounted within the duct in order to reverse the direction of air flow.

7. A ripening chamber as claimed in claim 1, wherein a controlled damper is provided in the kerb to allow air to be admitted into or expelled from the interior of the ripening chamber.
